(19) United States
(12) Patent Application Publication
(10) Pub. No.: US 2022/0248877 A1
(43) Pub. Date: Aug. 11, 2022

(54) MAGNETIC MOUNTING SYSTEM

(71) Applicants: Jeffrey L. Hooker, Cedar Hills, UT (US); Teresa M. Hooker, Cedar Hills, UT (US)

(72) Inventors: Jeffrey L. Hooker, Cedar Hills, UT (US); Teresa M. Hooker, Cedar Hills, UT (US)

(21) Appl. No.: 17/168,783

(22) Filed: Feb. 5, 2021

(51) Int. Cl. A47G 1/06

(52) U.S. Cl. CPC A47G 1/065; A47G 2001/0672; A47G 1/0616

(57) ABSTRACT

A magnetic mounting system may include a frame which has an upper surface which is covered by magnetic material and a piece of flexible image sheet attached to the frame so as to cover the frame. A plurality of mounting frames may be used and a plurality of pieces of image sheets magnetically attached so that the frame may not be seen between the image sheets.

### BACKGROUND

### State of the Art

The present invention relates to a magnetic mounting system for mounting images and the like.

### Field of Art

There are a variety of situations in which it is desirable to provide visual displays. The displays may provide marketing information, instructional information or simply a visual display for placement in a home or office. One common method for making a display is to mount plastic panels which have strips of magnetic material disposed thereon on a wall. As shown in FIG. 1, the panel, generally indicated at 4, includes a frame 8 made from plastic of similar material. The frame 8 includes a ridge or flange 12 extending upwardly around the exterior, and a plurality of pieces of magnetic sheets 16a which are separated by interior walls 20a. A central portion 24 of the panels typically include a plurality of cut outs or open sections 28 and additional magnetic sheets 16b extending outwardly from a center 32 and separated by interior walls 20b. A plurality of slots 36 are disposed in the central portion 24 so that the panels 4 can be attached to a wall by screws.

In order to present an image, a plurality of the panels are attached to a wall, as shown in FIG. 2 so that the panels 4 abut one another. One advantage of such panels is that an image can be placed on the panels by taking a plurality of image panels 40 which have a ferrous backing and attaching the image panels to the magnetic panels 4. Because the image panels 40 have a ferrous backing, the panels are held in place by the magnetic strips 16a and 16b on the magnetic panels 4. This allows a person to quickly place or remove an image from the array of magnetic panels 4 by simply placing the image panels 40 against the magnetic panels in a desired order to create the desired image. If the image being displayed is to be changed, the image panels 40 can be simply removed by hand and new image panels used to create a new image on the array.

The ease with which the image panels 40 can be attached to the magnetic panels 4 has made the panels very popular. They system, however, is not without its complications. First, the ridge or flange 12 about the exterior of the magnetic panel 4 divides the image seen by the customer, etc. with horizontal and vertical lines. Second, the image panels 40 are generally thick enough that the magnetic panels 4 can only hold a single depth of image panels magnetically. Thus, if a person desires to change the image, all of the image panels 40 must be removed from the magnetic panels and be replaced by the new image panels. This leaves the unattractive magnetic panels disposed during the changeover.

Yet another concern with this system is that the image panels 40 are thick and typically have to be printed on a flat bed press. Flat bed presses are very expensive, often exceeding $100,000 and are not owned by many printing businesses. Thus, the availability of printers who can create new image panels is limited—increasing the price for businesses and the like.

In an attempt to overcome the challenges of the prior magnetic panels systems, the inventors of the present application attempted to make magnetic panel systems using foam core boards 50. As shown in FIG. 3, a foam core board 50 were acquired in the size of approximately 18 inches by 18 inches. A magnetic sheet 56 has then adhesively attached to the foam core boards to form a magnetic panel 54. An image was then printed on magnetic receptive printing material (“receptive”), a ferrous sheet of material 60 which can be printed on with more conventional printers, and then cut down to match the size of the magnetic panel 54 formed by the foam core board 50 and the magnetic material to form image sheets 56.

The use of the magnetic panel 54 made from foam core board 50 and a magnetic sheet 56 was advantageous in that it allowed the use of receptive, significantly increasing the number of printers who could print the image sheets 60. However, the foam core boards in the size purchased include a boarder 68. When placed together in an array, the image still had noticeable intersecting lines 72 as shown in FIG. 4, though less noticeable than the system described with respect to FIGS. 1 and 2. Additionally, foam core board 50 is easily damaged, so care must be taken during shipping.

Within the last year, the inventors have attempted to get rid of the intersecting lines 72 by taking large foam core boards and cutting them down to the size of the image. The foam core boards were then covered with adhesive and then a sheet of magnetic material applied to the board. A sheet of receptive 76 with the image printed thereon was then applied to the foam core board to create a mountable image without the intersecting lines as shown in FIG. 5. While the images displayed were well liked because the lines did not disrupt the image, working with the large foam core board was very difficult. The foam core board could be easily damaged and required special shipping because of its size. Additionally, applying the magnetic sheet was difficult over a large area without creating bubbles between the foam core board, and the sheet of magnetic material could distort the image. Additionally, the large size of the foam core board images usually required two people to hang properly.

Thus, there is a need for a new magnetic mounting system which addresses the problems of the prior art.

### SUMMARY OF THE INVENTION

The following summary of the present invention is not intended to describe each illustrated embodiment or every possible implementation of the invention, but rather to give illustrative examples of application of principles of the invention.

In accordance with one aspect of the present disclosure, a panel is provided with a flat, generally continuous upper surface having lateral edges and a plurality of small recesses for mounting screws, and a sheet of magnetic material attached to the flat, generally continuous upper surface such that the magnetic material extends to within 2 mm of each of the lateral edges.

In accordance with one aspect of the present disclosure, the recesses have an underside which is provided with an adhesive attachment medium for attaching the magnetic panel to a wall.

In accordance with another aspect of the present disclosure, the recesses are sized and shaped to be less than ten percent (10%) of the area of the flat, generally continuous upper surface. More preferable, the recesses cover less than five percent (5%) of the surface area, and most preferably less than two percent (2%).

In accordance with another aspect of the present disclosure, a single sheet of magnetic material is applied to cover the flat, generally continuous upper surface.

In accordance with another aspect of the present disclosure, an image is printed on pieces of receptive which are sized to within 1 mm of the lateral edges of the panel.

In accordance with another aspect of the present disclosure, the image is printed on a piece of receptive and then cut to match the size of the magnetic panel.

In accordance with another aspect of the present disclosure, a plurality of pieces of receptive are disposed on a single magnetic panel so that images can be changed without exposing the magnetic panel.

### BRIEF DESCRIPTION OF THE DRAWINGS

Various embodiments of the present disclosure are shown and described in reference to the numbered drawings wherein:

FIG. 1 shows a front view of a magnetic panel formed in accordance with the teachings of the prior art;

FIG. 2 shows a front view of a plurality of image panels attached to plurality of magnetic panels disposed in an array with one image panel omitted to show a magnetic panel;

FIG. 3 shows a side view of a magnetic panel formed by foam core board and an image sheet formed by a piece of receptive in accordance with the prior art;

FIG. 4 shows a front view of an array of magnetic panels with image sheets disposed thereon;

FIG. 5 shows a front view of a large single magnetic panel formed by foam core board with a single image sheet disposed thereon;

FIG. 6 shows a front view of the magnetic panel in accordance with the teachings of the present disclosure;

FIG. 7 shows a rear view of the magnetic panel of FIG. 6;

FIG. 8 shows a side view of the magnetic panel of FIG. 6;

FIG. 9 shows an exploded side view of the plastic panel and the image sheet;

FIG. 10 shows a front view of an alternate shape of a magnetic panel disposed in an array;

FIG. 11 shows a front view of an alternate shape of a magnetic panel; and

FIG. 12 shows a front view of an alternate shape of a magnetic panel.

It will be appreciated that the drawings are illustrative and not limiting of the scope of the invention which is defined by the appended claims. The embodiments shown accomplish various aspects and objects of the invention. It will be appreciated that it is not possible to clearly show each element and aspect of the present disclosure in a single figure, and as such, multiple figures are presented to separately illustrate the various details of different aspects of the invention in greater clarity. Similarly, not all configurations or embodiments described herein or covered by the appended claims will include all of the aspects of the present disclosure as discussed above.

### DETAILED DESCRIPTION

Various aspects of the invention and accompanying drawings will now be discussed in reference to the numerals provided therein so as to enable one skilled in the art to practice the present invention. The skilled artisan will understand, however, that the methods described below can be practiced without employing these specific details, or that they can be used for purposes other than those described herein. Indeed, they can be modified and can be used in conjunction with products and techniques known to those of skill in the art in light of the present disclosure. The drawings and the descriptions thereof are intended to be exemplary of various aspects of the invention and are not intended to narrow the scope of the appended claims. Furthermore, it will be appreciated that the drawings may show aspects of the invention in isolation and the elements in one figure may be used in conjunction with elements shown in other figures.

Reference in the specification to “one embodiment,” “one configuration,” “an embodiment,” or “a configuration” means that a particular feature, structure, or characteristic described in connection with the embodiment may be included in at least one embodiment, etc. The appearances of the phrase “in one embodiment” in various places may not necessarily limit the inclusion of a particular element of the invention to a single embodiment, rather the element may be included in other or all embodiments discussed herein.

Furthermore, the described features, structures, or characteristics of embodiments of the present disclosure may be combined in any suitable manner in one or more embodiments. In the following description, numerous specific details may be provided, such as examples of products or manufacturing techniques that may be used, to provide a thorough understanding of embodiments of the invention. One skilled in the relevant art will recognize, however, that embodiments discussed in the disclosure may be practiced without one or more of the specific details, or with other methods, components, materials, and so forth. In other instances, well-known structures, materials, or operations may not be shown or described in detail to avoid obscuring aspects of the invention.

Before the present invention is disclosed and described in detail, it should be understood that the present invention is not limited to any particular structures, process steps, or materials discussed or disclosed herein, but is extended to include equivalents thereof as would be recognized by those of ordinary skill in the relevant art. More specifically, the invention is defined by the terms set forth in the claims. It should also be understood that terminology contained herein is used for the purpose of describing particular aspects of the invention only and is not intended to limit the invention to the aspects or embodiments shown unless expressly indicated as such. Likewise, the discussion of any particular aspect of the invention is not to be understood as a requirement that such aspect is required to be present apart from an express inclusion of that aspect in the claims.

It should also be noted that, as used in this specification and the appended claims, singular forms such as “a,” “an,” and “the” may include the plural unless the context clearly dictates otherwise. Thus, for example, reference to “a bracket” may include an embodiment having one or more of such brackets, and reference to “the target plate” may include reference to one or more of such target plates.

As used herein, the term “substantially” refers to the complete or nearly complete extent or degree of an action, characteristic, property, state, structure, item, or result to function as indicated. For example, an object that is “substantially” enclosed would mean that the object is either completely enclosed or nearly completely enclosed. The exact allowable degree of deviation from absolute completeness may in some cases depend on the specific context, such that enclosing the nearly all of the length of a lumen would be substantially enclosed, even if the distal end of the structure enclosing the lumen had a slit or channel formed along a portion thereof. The use of “substantially” is equally applicable when used in a negative connotation to refer to the complete or near complete lack of an action, characteristic, property, state, structure, item, or result. For example, structure which is “substantially free of” a bottom would either completely lack a bottom or so nearly completely lack a bottom that the effect would be effectively the same as if it completely lacked a bottom.

As used herein, the term “generally” refers to something that has characteristics of a quality without necessarily being exactly that quality. For example, a structure said to be generally vertical would be at least as vertical as horizontal, i.e., would extend 45 degrees or greater from horizontal. Likewise, something said to be generally circular may be rounded like an oval but need not have a consistent diameter in every direction.

As used herein, the term “about” is used to provide flexibility to a numerical range endpoint by providing that a given value may be “a little above” or “a little below” the endpoint while still accomplishing the function associated with the range.

As used herein, a plurality of items, structural elements, compositional elements, and/or materials may be presented in a common list for convenience. However, these lists should be construed as though each member of the list is individually identified as a separate and unique member.

Concentrations, amounts, proportions and other numerical data may be expressed or presented herein in a range format. It is to be understood that such a range format is used merely for convenience and brevity and thus should be interpreted flexibly to include not only the numerical values explicitly recited as the limits of the range, but also to include all the individual numerical values or sub-ranges encompassed within that range as if each numerical value and sub-range is explicitly recited. As an illustration, a numerical range of “about 1 to about 5” should be interpreted to include not only the explicitly recited values of about 1 to about 5, but also include individual values and sub-ranges within the indicated range. Thus, included in this numerical range are individual values such as 2, 3, and 4 and sub-ranges such as from 1-3, from 2-4, and from 3-5, etc., as well as 1, 2, 3, 4, and 5, individually. This same principle applies to ranges reciting only one numerical value as a minimum or a maximum. Furthermore, such an interpretation should apply regardless of the breadth of the range or the characteristics being described.

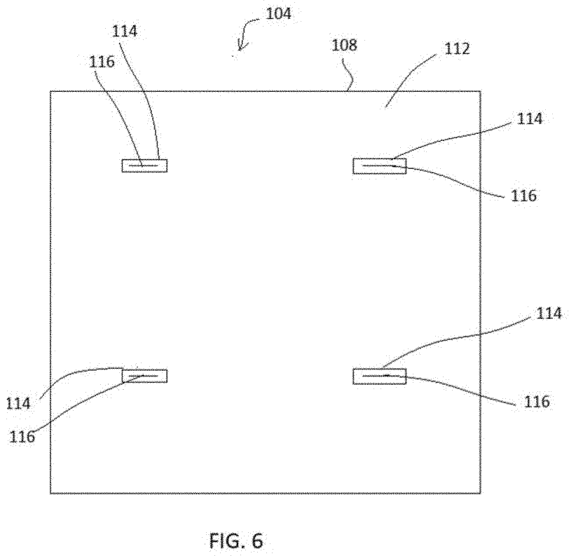

Turning now to FIG. 6, there is shown a front view of a frame 108 of a magnetic panel, generally indicated at 104. The frame 108 may be made from a plastic or plastic like polymer such as acrylonitrile butadiene styrene (ABS). In this example the frame 108 may be 18 in. by 18 in. (45.72 cm×45.72 cm) so that the upper surface 112 is approximately 324 square inches. The frame 108 may also be made in other sizes as desired.

The upper surface 112 may be flat or substantially flat and generally continuous with the exception of a plurality of recesses 114 formed therein. In the embodiment shown in FIG. 6, the recesses may be 1.5 inches (3.81 cm) long by 0.5 inches (1.27 cm) wide, thus having a total area of 0.75 inches each at the upper surface 112 for each recess. With four such recesses, the total area of the upper surface width is not flat and continuous is 3 square inches, or less than 1 percent (1%) of the total surface area of upper surface of the plastic frame 108.

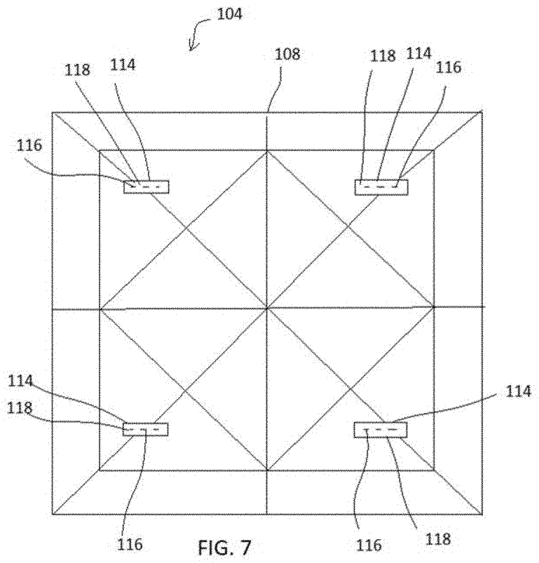

Each of the recesses 114 may include a slot 116 through which a screw can be driven. The slots may be for example ⅛^{th} inch (0.312 cm) wide and ¾ths of an inch (1.91 cm) long. This allows a user to attach the panel 104 to a wall with screws or nails if desired. FIG. 7 shows a backside of the panel. Each of the recesses 114 may include a generally flat bottom 118 which may be covered with an adhesive material such that the panels can be releasably attached to a wall with the adhesive material—thereby preventing damage to the wall in the event that the user decides to remove or relocate the panels. (Thus in FIG. 7, the slots 116 are shown in dashed lines).

The back side of the panel 104 may have a plurality of intersecting support walls 122. The walls are preferably thin (i.e.) less than 1/16^{th} of an inch wide, so as to provide support to the upper surface, while providing minimal weight. Thus, the amount of flat surface on the back of the panel which engages the wall may be little more than 1 percent (1%) of the overall area of the backside of the panel—reducing wear marks, etc., on the wall.

The panel 104 can be very light weight and still provide the rigidity necessary to provide a pleasing image. For example, the frame 108 may be any desired thickness. Common thicknesses are likely to be between 0.25 inches (0.64 cm) and 0.75 inches (1.9 cm) thick, with 0.4-0.6 inches (1-1.5 cm) being preferred.

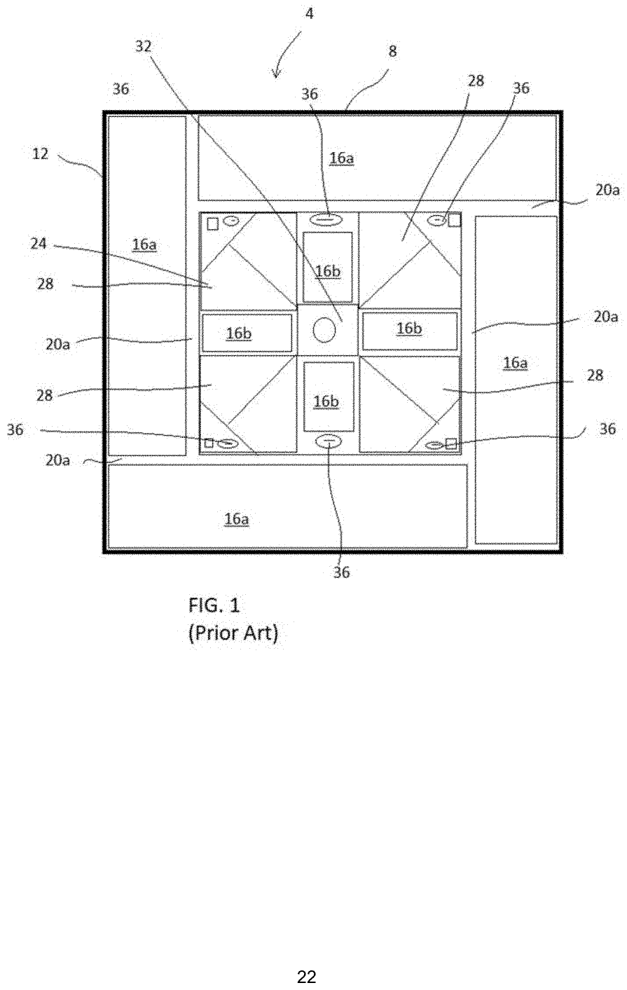

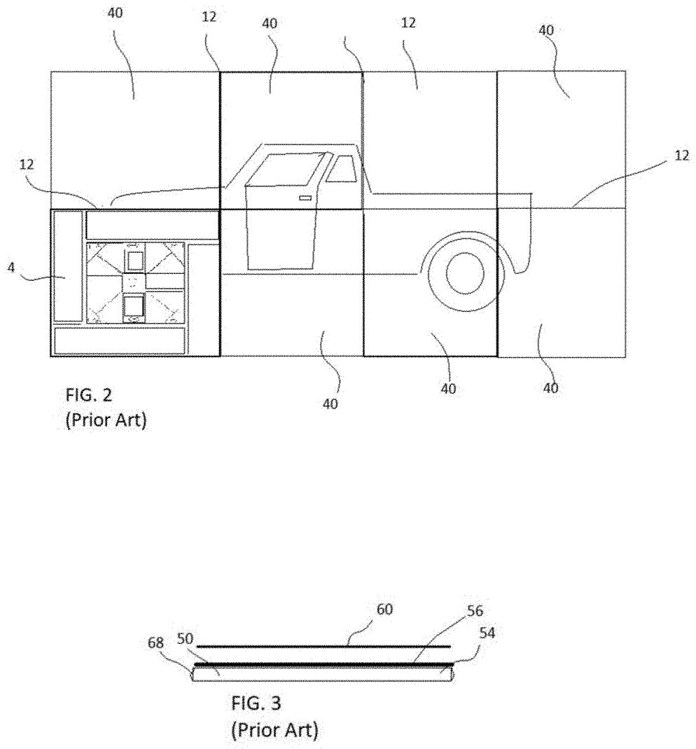

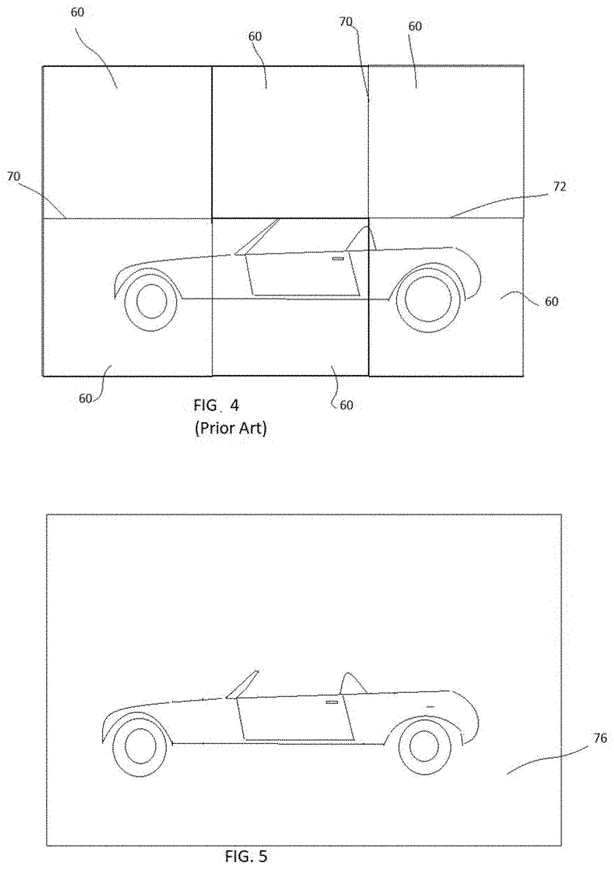

The image panels (12, FIG. 2) prior art discussed above are heavy and less flexible, so there is not a great need to have the panel provide a smooth surface for magnetic engagement. The thickness also inhibits the ability of the magnetic material (16a, 16b, FIG. 1) to hold multiple panels. In contrast, receptive is substantially lighter and more flexible than the image panels and will become distended if not supported properly. Thus, for example, if one were to use receptive on the panel 4 shown in FIG. 1, the voids in the frame between the magnetic strips would allow the receptive to sag—thus negatively impacting the look of the image. In contrast, by having at least 90% of the upper surface or of the frame covered with magnetic material, the flexible receptive is provided with a support that substantially lessens the risk of the frame structure being conformed to by the receptive and thus visible to the observer. A flat, generally continuous surface of at least 95% is preferred, and a flat generally continuous surface of at least 98% is most preferable, as sagging is generally not present, and the image provides a clean image.

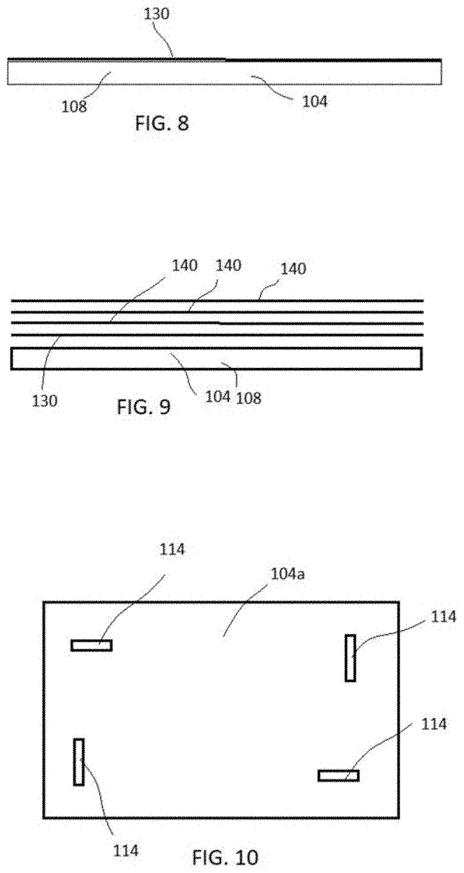

Turning now to FIG. 8, there is shown a side view of the magnetic panel 104. The frame 108 is covered by a sheet of magnetic material 130. To minimize disruptions to the image sheets, it is preferred that a single sheet of magnetic material is used. However, the upper surface can be covered by multiple pieces disposed immediately adjacent one another. The magnetic material 130 is preferable attached to the frame 108 right of the lateral edges of the frame, or less preferably withing 1-2 mm of the lateral edges of the frame. When multiple frames 104 are placed side to side, the magnetic material 130 forms a substantially continuous magnetic layer and no flanges interrupt the continuity. In fact, if multiple magnetized panels are disposed side by side, a single image sheet can be laid over them due to the lack of flanges, etc.

Turning to FIG. 9, there is shown an exploded view of a magnetic panel 104 and a plurality of image sheets 140. In use, the magnetic material 130 will be applied to the frame 108, typically by an adhesive. Once the magnetic material 130 is attached, image sheets 140 made of receptive or other ferrous material can be attached to the magnetic material. Unlike the thick material used in the prior art, the receptive sheets are thin enough that multiple receptive sheets can be held in place at the same time. This allows a user to place multiple images in place and then to simply peal off the image sheets for one image to thereby expose the image below. Thus, in a single day a company could have a sign provide three different messages without ever having to expose the upper surface of the frame 108.

Additionally, because the magnetic sheets 130 extend to the lateral edges, a single image sheet 140 or a plurality of smaller image sheets may be used to cover an entire array of magnetic panels 104 without deforming the image being shown. Even with smaller image sheets used and abutted side by side. The virtually continuous magnetic sheet underneath holds them together so the line between the individual image sheets can only be seen upon a close inspection. This allows what appears to be a larger image, e.g., 4.5 feet×6 feet can be shown while appearing to be a single image even though it is made up on smaller pieces.

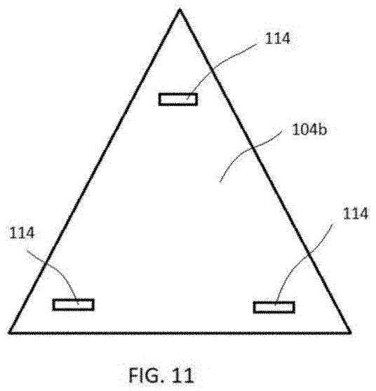

Turning now to FIGS. 10, 11 and 12, there are shown magnetic panels 104a, 104b and 104c in which different shapes are used. The magnetic panels 104a-104c can be used with like-shaped image sheets (not show) to provide overall images having a plurality of different shapes—while appearing to be (or actually being) a single image without distracting intervening lines. It will be appreciated that the recesses 114 can be in any of a variety of orientations to facilitate placement of the magnetic panels without interfering with the images being shown thereon. The magnetic material disposed on the magnetic panels 104a-104c would preferably match the shapes thereof and extend to within about 1 mm or less of the lateral edges of the panels.

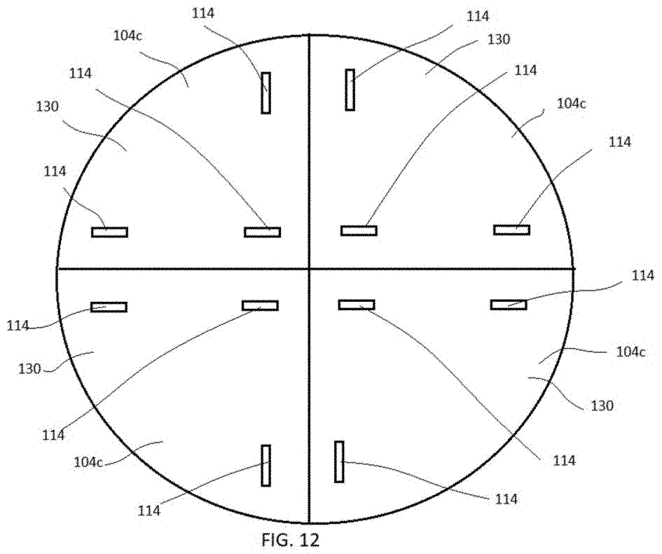

In FIG. 12, a plurality of pie shaped magnetic panels 104c are placed together to form a circle. It will be appreciated that a plurality of image sheets could be placed on the magnetic panels so that one image sheet covers each panel. Alternatively, two image sheets could be used to cover the four magnetic panels, or a single image sheet could be used to cover all four. Because the magnetic material 130 covers right up to the edges of the panels, there are only a few areas where the image sheets are not completely supported by the magnetic material, thus preventing drooping or other distortions of the image sheets.

Thus, there is disclosed a magnetic mounting system and method for using the same. It will be appreciated that modifications can be made without departing from the scope and spirit of the invention. The appended claims are intended to cover such modifications.

What is claimed is:

1. A magnetic mounting system comprising:
a frame having a flat, generally continuous upper surface and a magnetic material disposed thereon, the magnetic material covering at least 90% of the upper surface.

2. The magnetic mounting system according to claim 1, wherein the frame has lateral sides and wherein the magnetic material extends to within 1 mm of the lateral sides.

3. The magnetic mounting system according to claim 1, wherein the frame has lateral sides and wherein the magnetic material covers at least 90% of the area between the lateral sides.

4. The magnetic mounting system according to claim 1, wherein the frame has lateral sides and wherein the magnetic material covers at least 95% of the area between the lateral sides.

5. The magnetic mounting system according to claim 1, wherein the frame has lateral sides and wherein the magnetic material covers at least 98% of the area between the lateral sides.

6. The magnetic mounting system according to claim 1, wherein the upper surface has a plurality of recesses formed therein and wherein the recesses are less than 10% of the area of the upper surface.

7. The magnetic mounting system according to claim 1, wherein the upper surface has a plurality of recesses formed therein and wherein the recesses are less than 5% of the area of the upper surface.

8. The magnetic mounting system according to claim 1, wherein the upper surface has a plurality of recesses formed therein and wherein the recesses are less than 2% of the area of the upper surface.

9. The magnetic mounting system according to claim 1, wherein the frame has a back side and wherein less than 2% of the back side of the frame is flat.

10. The magnetic mounting system according to claim 1, wherein the frame has recesses formed therein, and wherein the recesses have adhesive material attached thereto.

11. A magnetic mounting system comprising:
frame having an upper surface with is flat and generally continuous over at least 90% of the upper surface; and
a sheet of magnetic material attached to the upper surface, the sheet of magnetic material covering at least 90% of the upper surface.

12. The magnetic mounting system of claim 11, wherein the frame has lateral edges and wherein the magnetic material extends to within 1 mm of the lateral edges.

13. The magnetic mounting system of claim 11, further comprising a sheet of receptive having an image disposed thereon magnetically attached to the magnetic material so as to extend to the lateral edges of the frame.

14. The magnetic mounting system of claim 13 wherein a single piece of receptive is attached to multiple frames by magnetic material.

15. A method for mounting an image, the method comprising:
attaching a frame to a wall, wherein the frame has an upper surface disposed on an opposite side from the wall, the frame having lateral edges and the upper surface extending between the lateral edges and magnetic material attached to the upper surface so as to cover at least 90% of the area between the lateral edges; and
magnetically attaching at least one piece of receptive to the magnetic material such that the receptive extends at least to the lateral edges of the frame.

16. The method according to claim 15, wherein the method comprises attaching a plurality of pieces of receptive to a single frame.

17. The method according to claim 15, wherein a single piece of receptive covers a plurality of frames.

18. The method according to claim 15, comprising multiple pieces of receptive being disposed side by side and magnetically attached to a plurality of frames so that the frames cannot be seen between the pieces of receptive.
